(19) United States
(12) Patent Application Publication
(10) Pub. No.: US 2005/0033991 A1
(43) Pub. Date: Feb. 10, 2005

(54) Apparatus for and method of evaluating security within a data processing or transactional environment

(76) Inventor: Stephen James Crane, Nr Bristol (GB)

Correspondence Address: HEWLETT-PACKARD COMPANY;Intellectual Property Administration, P.O. Box 272400, Fort Collins, CO, 80527-2400, US

(21) Appl. No.: 10/877,833

(22) Filed: Jun. 24, 2004

(30) Foreign Application Priority Data
Jun. 27, 2003 (GB) 0314970.5

(51) Int. Cl. G06F 11/30

(52) U.S. Cl. 713/201

(57) ABSTRACT

An apparatus for evaluating security within a data processing or transactional environment, comprising a data processor arranged to interrogate the data processing or transactional environment to determine what devices or applications exist with the environment and their operating state, to evaluate this data and to provide an indication of the security of the environment or trust that can be placed in the environment.

### FIELD OF THE INVENTION

The present invention relates to an apparatus for and method of evaluating security that may be placed within a data processing or transactional environment. In this context the term security includes a measure of the trustworthiness of the environment to respect a user's data. The invention is then able to report the level of trust to a user that the user should place in that environment, and effectively functions as a personal trust assistant (PTA).

### BACKGROUND OF THE INVENTION

The traditional balance of security in computing systems is strongly in favour of the system owner. Thus when a user attempts to interact with a system it is usually the user's authority to use the system that is challenged by the system owner or provider. Typically the system challenges a user to identify themselves by revealing a shared secret, such as a user log-on and user password. Seldom is the user permitted to challenge the ability of the system provider to deliver either a chosen service or to meet the user's security expectations. One reason for this imbalance is that the user is generally unable to investigate the complex cryptographic protocols that need to be exchanged in order to provide security within a computing system. Furthermore, even if users have the ability to interrogate these protocols they would generally lack the expertise in order to interpret the results. Thus users often have to believe that the systems they interact with are trustworthy, even though the ease with which web sites can be set up makes it easy for malicious individuals to open such sites.

In practise users normally “trust” the device that is local to them especially if it is personal and owned by them. This level of trust may or may not be valid. Thus trusting your local computer may be appropriate when it is a home PC and believed to be running in a virus free configuration. That level of trust may or may not be appropriate on a corporate network and may be totally misguided for a computer in a public access place such as an internet café. Beyond this level of trust the users would look for signs of trustworthiness in the system with which they interact. Thus one item of trust is the frequently observed “SSL secured” padlock that appears in the status bar of an internet browser.

### SUMMARY OF THE INVENTION

According to a first aspect of the present invention, there is provided an apparatus for evaluating security within a data processing or transactional environment, comprising a data processor arranged to interrogate the data processing or transactional environment to determine what devices or applications exist with the environment and their operating state, to evaluate this data, and to provide an indication of the security of the environment or trust that can be placed in the environment.

It is thus possible to provide users with the means to establish for themselves how trustworthy the system that they intend to use really is.

Advantageously different levels of security or trust can be catered for. Thus a user who is dealing with corporate information may wish to, or may be required to, seek greater levels of security than they might otherwise need when dealing with their personal information. The requirements which a user wishes to have satisfied by the computing (data processing or transactional) environment with which they wish to interact may be defined in a policy. Advantageously a single apparatus, which may be regarded as a trust assistant, may contain a plurality of policies which may be invoked depending upon the role the user is assuming. Thus one policy may be invoked for business use and another policy may be invoked for private use. Different policies may be applied to different operations within their business and personal environments.

Advantageously the trust assistant is able to determine an objective (or quantative) determination of the security that is provided by a data processing environment. This may, for example, be achieved by interfacing with that environment and seeking from that environment a list of connections and devices within the environment and also their software build status. It is known to form integrity metrics of a software environment, for example by forming hashes of the executable code within that environment and comparing the hash value with an expected value for that code. Any discrepancies between the expected software build and the or each integrity metric associated with it may suggest that the reliability of one or more devices or applications within the software environment has been undermined and may not be trustworthy. Systems to provide reliable and trusted indications of integrity are known. An example of such a system is the TCPA architecture as defined at www.trustedcomputing.org. TCPA compliant systems base their trustworthiness on the provision of a trusted tamperproof component which is tightly bound with the structure of the computer. The trusted component monitors the build of the BIOS, operating system and applications and keeps a dynamic log of the software (and optionally hardware) components together with integrity metrics relating to these components. The dynamic log can then be made available to another party which wishes to assess the trustworthiness of the computing environment. The dynamic log can be trusted since it is produced by an intrinsically trusted component which signs the data in order to authenticate its source and reliability.

The trusted component can be authenticated if desired as it has at least one secret which it shares with a certification authority which can then vouch for the identity of the trusted component.

Advantageously the personal trust assistant also provides a subjective (or quantative) indication of trustworthiness. A subjective view of trust is unlikely to provide the same level of user confidence as an objective view, but in many situations this may be regarded as better than nothing.

Advantageously the personal trust assistant is a device which is tightly associated with one or more owners and effectively forms a trust domain with them. This requires that the user can identify themselves to the device. This may be by way of entering a password or other secret shared between the individual and the apparatus. However, for ease of use, biometric data may be used to identify an individual to the device. Biometric data is a preferred form of identification. The reason for this is that whilst the use of a password or shared secret is a useful form of authentication, it does not enable the PTA to confirm that the user's identity is valid. Put another way entry of a password only proves that the person who entered the password knew the password. Strictly speaking it does not identify the individual. Biometric data, if sufficiently well particularised, is individual to a user and hence confirms the individual's identity to the PTA. Suitable candidate technologies include fingerprint identification, voice recognition, retinal scanning and iris scanning. Of these iris scanning is particularly suitable technology since it provides a high level of individual decoding (i.e. identification), requires only a relatively modest camera to view the user's eyes and is non invasive. A user's biometric data may be permanently stored within the personal trust assistant. However, in an embodiment of the invention the user's biometric data is stored on a removable memory element, for example a smartcard. The smartcard includes local processing and cryptographic security and can be arranged such that it will only release the biometric information to a trusted device, for example a generic family of personal trust assistant devices, a sub-selection of those devices, or even to only a single personal trust assistant device. This release of biometric information can be related to the exchange of a shared secret or secrets between the smartcard and the personal trust assistant. Thus when the user inserts the smartcard (which effectively functions as a key or a token) into the personal trust assistant, the personal trust assistant then negotiates with the smartcard to access the user's biometric data and then checks the user's biometric data, for example the user's iris pattern, against a measurement of that biometric data made by the personal trust assistant. Thus the personal trust assistant may use an inbuilt imaging device to capture an image of the user's iris. As a further alternative the personal trust assistant passes the biometric data that it has captured to the removable memory element. The removable memory element then uses an on board processor within it to compare the biometric data and to return the results of the comparison to the personal trust assistant. Thus the PTA never gets to manipulate or obtain access to the master copy of the biometric data.

The removable memory element (smartcard) may contain other information which is personal to the user, for example the user's social security or national security number. Exactly what information the user chooses to store within the memory element will depend on the user's preferences.

Advantageously the personal trust assistant keeps the user's policy or policies stored within a secure memory. Alternatively, the device may seek to download the policies once the user has identified themself to it. The policies may be downloaded from a trusted policy store which may be provided by a commercial organisation or indeed the user's business.

Advantageously the personal trust assistant monitors the proximity of the user and deletes the user's policy information (and any identity or biometric data if stored in the personal trust assistant) if it determines that it has become separated from its user. This may, for example, be achieved by requiring the user to keep hold of the personal trust assistant. Alternatively it can monitor for its proximity to a tag or other identifier worn or carried by the user. The tag or identifier may be a low power radiative device, such as either an active or passive transmitter worn by the user. Thus the transmitter could be incorporated into an item of jewellery or a watch, for example. RF identification tags allow for encryption and local data processing so it is possible to establish a secure session identifier for each time the tag and the personal a trust assistant to communicate with one another.

Advantageously the personal trust assistant is incorporated within the personal computing device, such as a personal digital assistant, within a mobile telephone, a watch or some other item that the user generally carries with them or has about their person. However, the personal trust assistant may also be incorporated within larger items, such as personal computers or corporate computing systems.

Advantageously the personal trust assistant has environmental sensors in order to help it determine a subjective measurement of trust concerning an environment. Subjective measurements are, by their very nature, difficult to define. However the personal trust assistant may include a camera, a microphone or ultrasonic detecting means in order to try and determine the proximity of another person or persons to the user. Such proximity may effect the subjective level of trust. For example, if the user is at an automatic teller machine and is about to make a cash withdrawal then the abnormally close proximity of other people may suggest that the user should not complete the transaction with the automatic teller machine. The personal trust assistant could provide an indication to the user to this effect. Similarly, the personal trust assistant may include position determining means, such as inertial navigational systems, GPS based systems, or triangulation systems using the mobile telephone infrastructure or some other infrastructure to give an indication to a user when they are entering geographical areas where a greater level of caution should be exercised. The apparatus may further use time as an input for determining a subjective level of trust. Thus, on the basis of information provided by a policy provider the trust assistant may indicate to a user that they have entered an area known to have a crime problem (either generally or at a specific time, such as night time). The PTA may also include a light level sensor. Such a relatively simple sensor can still help the PTA to distinguish between night and day, indoors and outdoors (electric lights often have intensity fluctuations at the AC supply frequency or a harmonic thereof) or when the user is moving into a shaded place or an alley.

Advantageously, once the personal trust assistant has derived an estimate of the trust that can be placed in the computing system with which the device and user wishes to co-operate or the transaction environment in the vicinity of the user or general environment around the user, it gives an indication to the user in an iconic or graphical form. Thus the indication of trust may be given as a traffic light display with green indicating that the environment is trustworthy, amber indicating that caution may need to be applied and red indicating that the environment is not trustworthy. Alternatively bar graphs, gauges or expressions on faces may also give an easily user interpretable display of the level of trust as determined by the personal trust assistant.

Advantageously the PTA can act as an agent for the user. The PTA may allow the user to enter one or more task rules governing the behaviour of the PTA during the performance of a task. A user may, for example, enter an on-line auction (ie a transactional environment) and instruct his PTA to bid for him within specified constraints, as defined in the task rules. In this example the PTA is effectively the user (by virtue of its identification data and close proximity to the user) and is trusted by the auctioneer to represent the user's intentions. It is therefore advantageous for the auctioneer to test the trustworthiness of the PTA. Advantageously the PTA is a trusted device, for example built in conformity with the TCPA specification. Thus the auctioneer and the PTA engage in a peer-to-peer conversation to determine each others properties and trust.

Preferably the PTA can act as a identity management device. Following user authentication the PTA can hold personal and/or identity information about the user which can be selectively released to other computing systems, subject to the system which is requesting the information being judged to be trustworthy.

Preferably the personal trust assistant can support individualised policies for a variety of operations or applications that the user wishes to perform. Advantageously the user can select from a list the operation that they wish to perform. For example, if the user intends to access an online merchant then the user selects this option, thereby causing the appropriate policy to be activated.

According to a second aspect of the present invention there is provided a method of evaluating security or trust within a data processing or transactional environment, comprising the steps of: using an investigation means or agent to investigate what devices or applications exist within the environment and to determine their operating state; and using this data to provide an indication of the security or trust that can be placed in the environment.

According to a third aspect of the present invention there is provided a personal trust assistant comprising a portable data processing device having a policy memory for holding at least one trust policy giving indications of at least one item selected from a list comprising conditions to be satisfied for an environment to be considered safe, conditions to be satisfied for an environment to be considered trusted, and conditions which cause an environment to be considered unsafe or untrusted, and environment sensors for collecting environmental information, and wherein the data processor compares the environmental information with the policies and on the basis of the comparison gives an indication to the user of the safety or trust of the environment.

The environment may be the computing and/or transactional environment accessible to the personal trust assistant. Additionally the PTA may also be responsive to the physical environment around it.

The PTA may include communication means for establishing communication with a policy server so as to download a user's policy or policies following authentication of the user with the PTA. Thus the PTA can be a blank machine (i.e. it has no user data within it) until such time as a user authenticated with the PTA. In such an arrangement all PTA's may be blank until used, and hence can be lent or borrowed without any security breaches as the PTA binds with and becomes personal to each individual user.

According to a fourth aspect of the present invention there is provided a computer program for causing a programmable data processor to operate in accordance with the second aspect of the present invention.

The computer program product may run within a portable computing device, a user's laptop or desktop computer, or within a corporate computing infrastructure. Thus the trust assistant may seek to evaluate the level of trust which can be accorded to devices attempting to communicate with the computing device or corporate infrastructure operating in accordance with the present method.

According to a fifth aspect of the present invention there is provided a policy server arranged to, upon establishment of communication with a personal trust assistant, seek confirmation of a user identity, to locate a user's at least one policy, and to download at least a selected one of the user's policies to the personal trust assistant for use by the personal trust assistant.

### BRIEF DESCRIPTION OF THE DRAWINGS

The present invention will further be described, by way of example, with reference to the accompanying drawings, in which:

FIG. 1 schematically illustrates the internal configuration of a personal trust assistant constituting an embodiment of the present invention;

FIG. 2 schematically illustrates a second embodiment of a personal trust assistant;

FIG. 3 schematically illustrates a mobile phone based personal trust assistant extending a corporate trust domain; and

FIG. 4 schematically illustrates the interaction between a personal trust assistant and a distributed computing environment.

### DESCRIPTION OF PREFERRED EMBODIMENTS

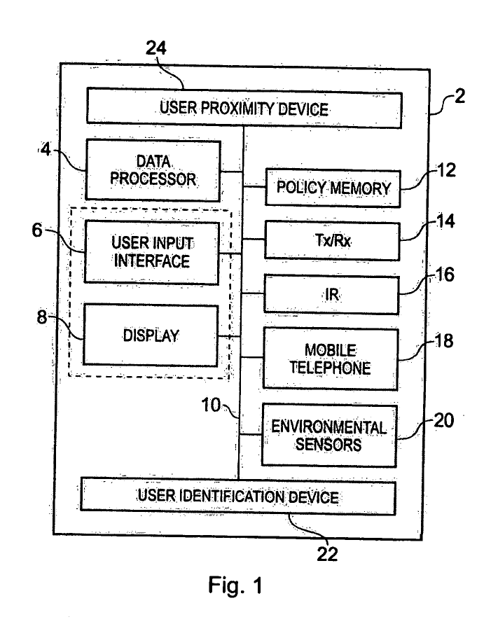

FIG. 1 schematically illustrates a personal trust assistant 2 constituting an embodiment of the present invention. The personal trust assistant 2 may be embodied within a personal digital assistant or a mobile telephone. The personal trust assistant 2 comprises a data processor 4 which can communicate with a user input device 6 and a display 8 over a databus 10. The user input device 6 may comprise a key pad, or may be integrated within the display, for example using touch screen technology to pick letters or words from the display device in order to enter data. The trust assistant 2 also includes a policy memory 12 in which one or more user policies are stored. The policies define the conditions which the user wishes to see satisfied in order to determine an acceptable level of trust. More than one level of trust may be defined an one or more policies may be included within the memory. The personal trust assistant 2 also includes a local wireless data communications device 14 for establishing wireless communications, for example in accordance with the 802.11A specification, Bluetooth or any other appropriate standard or protocol, with suitably enabled computer devices. The personal trust assistant 2 may also include an infrared port 16 for establishing infrared communication with suitably enabled devices. The personal trust assistant 2 also includes a mobile telephone interface 18 for establishing data communication and/or voice calls and/or positional information via the mobile telephone infrastructure. The PTA may also include physical connectors for interfacing with a docking station or other computers, for example via a universal serial bus connection or the like.

The personal trust assistant 2 advantageously also includes environmental sensors 20 in order to ascertain additional information which may be used to make a subjective modification or estimation of the level of trust. The environmental sensors 20 may include a proximity detector for detecting the presence of nearby persons. The proximity detector may be based on an optical camera, microphone, ultrasonics or other suitable systems. The environmental sensor 20 may also include a positioning system, such as a GPS system to determine the position of the device, a time keeping element such that transactions which are being performed at an unusual time may be deemed as less trustworthy. The personal trust assistant 2 also includes a user identification device 22 which advantageously is a biometric device such as an iris scanner in order that a user can authenticate with the personal trust assistant. Iris scanners may be implemented using relatively inexpensive CCD cameras and suitable software. Iris scanning technology is available from a number of vendors, for example iridian technologies, and therefore specific implementation of such technology does not need to be described further. The user identification device 22 also includes a memory for the biometric data such that the measurement of biometric data made during the user authentication with the personal trust assistant can be compared with previously stored biometric data representing the user. The biometric data memory may be permanently embedded within the personal trust assistant or may be carried on a removable memory element, for example a smartcard. The removable memory element may allow the PTA to access the biometric data contained in the removable memory. Alternatively where the removable memory contains local processing the biometric analysis and user authentication may be performed solely within the removable memory. Additionally, the personal trust assistant includes a user proximity determining device 24, such as touch sensors or motion sensors or RF tags or video object monitoring which monitor the likelihood that the device has remained in proximity to the user. Each of these components communicate with the data processor via the databus 10. The personal trust assistant may also be responsive to the user's state of anxiety, and may factor in the user's physical responses, such as production of sweat or changes in skin resistance, as part of a subjective assessment of the trustworthiness of the environment.

In use, the user identifies themselves to the personal trust assistant 22 via the user identification device. Thus, once the user has completed, for example, the iris scan and been identified, the device retrieves the user security policies from the policy memory 12, where they may have been stored in encrypted form, or downloads them over a data link to a policy server established using the mobile telephone 18.

The data processor then seeks to identify what other computing devices are within the computing or transactional environment by interrogating them through the radio and infrared ports 14 and 16. Simultaneously the user proximity device monitors the proximity of the personal trust assistant to the user. In implementations where proximity is based on user movement or the user holding the device, the user's policies may be erased either immediately that the proximity device determines that the personal trust assistant is no longer in proximity with its owner, or after a predetermined period of time if no such proximity is re-established.

The user can interface with the personal trust assistant in order to indicate what kind of transaction he would like to undertake and the personal trust assistant can use this knowledge, together with any information derived from the local computing environment via the data interfaces 14 and 16 to assess whether it has sufficient information to categorise the transactional environment as trustworthy. If it cannot categorise the environment as safe or trusted, then it informs the user of this.

The personal trust device effectively acts as the user “best buddy” and it is personal, intimate and highly trusted by the user. Because of this tight association between the user and the device the user and the personal trust assistant can be considered to be combined to form a personal trust domain. As noted hereinbefore the personal trust assistant is small enough to be easily and conveniently carried about the person and is therefore particularly suited to a mobile lifestyle. It may take the form of a stand alone device such as a badge or a watch or may be combined with another device that the user already has and expects to trust and protect, such as a PDA or mobile phone. Indeed, incorporating the personal trust assistant functionality into an existing personal appliance is particularly attractive as these personal appliances are already perceived as valuable and trustworthy.

As noted hereinbefore, the personal trust assistant probes the environment to determine whether it is safe for the user to perform a transaction within that environment. The personal trust assistant already has an expectation of what a trusted environment should look like and this expectation will either be represented as policies imposed by the user, the user's employer or beliefs held by the user or policies made available by commercial or other suppliers. Multiple policies can be applied and hence the same device can be used for both business and leisure related activities. Each of the policies is intended to describe a set of minimum requirements that must be fulfilled to establish trustworthiness. These requirements are expressed as proofs of the target systems, that is the system which the personal trust assistant is interrogating, is expecting to have one or more of. These proofs or policies may include that the target system is certificated by a company or organisation that the user trusts, that it incorporates a trusted computing module or satisfies some other test which gives an indication that the device is likely to be trustworthy, although of course it is highly unlikely that any absolute guarantee of trust can be given. These technical measurements, and measurements of the level of cryptographic encoding used, of the computing environment give rise to an objective or proof based approach in determining the level of trust.

In addition a secondary subjective or belief based approach is available that uses indicators to give a reason to believe that the target system (or indeed general environment) should be trusted, e.g. because of its location, for example it is a computer maintained within a building which belongs to an organisation which is regarded as trustworthy, that a third party recommendation has been received, that the party with whom you wish to act has a reputation, or that the general surrounding is believed to be trustworthy, or indeed that the quality of the interaction suggests that the environment is trustworthy. Typical indicators of the quality of the interaction are the speedy delivery of integrity measurements.

The personal trust assistant may also monitor changes in the transactional environment. Thus changes in the environment which causes it to be less trustworthy such as the trusted module reporting that a new unidentified process is running within the target machine, may cause the personal trust assistant to re-evaluate the level of trust that is wishes to ascribe to the target system and it can alert the user of this change.

Proof based indicators will generally be treated with a higher significance than subjective indicators and are weighted accordingly. However users may still wish to consider weaker indicators if the user has particular beliefs about the interaction. An exception could be where a change in the local environment raises a weak alert that overrides stronger indicators. For example, where the PTA receives an alert from a third party or where the user moves to a potentially hazardous location, such as away from company premises. Where only subjective indicators are available, users can still choose to use them but must be aware of the limitations. For certain lower risk applications these may still be perfectly adequate.

The personal trust assistant may be programmed to learn the user's pattern of use and willingness to accept risks based on the users past experience and can therefore over time offer a personalised service to the user. By maintaining a history of past experiences the personal trust assistant can also alert the user to seek sequences of events or situations which mirror past dangers and advise accordingly.

Once the trust assistant has determined the level of trust that is to be placed in the transactional system, it has to alert the user. Exactly how this happens can vary depending on the application and form of the personal trust assistant device. However a visual interface 8 is a particularly preferred option and the personal trust assistant can communicate its analysis to the user through a hierarchy of icons that represent at the highest level that the intended interaction is safe, down to specific icons that indicate areas where a potential risk lies. The icons enhance the user's understanding of the environment, enabling them to judge for themselves whether it is safe or correct to proceed without necessarily requiring an in-depth understanding of the policies and how they are applied.

In a preferred embodiment of the present invention the personal trust assistant can record four possible outcomes:
Policy fulfilled—safe to proceed.
Policy substantially fulfilled—proceed with caution.
Policy partially fulfilled—procedure not recommended.
Policy not fulfilled—not safe to proceed.

Each level of fulfilment is described with a different icon thus in the above list the first icon might be coloured green, the second and third coloured amber and the last coloured red. Furthermore an image or icon can be displayed representing the intended application/operation that the user wishes to perform. Thus the user is given a review of the operation he wishes to perform plus an indication of whether the policies are satisfied.

This information need not be given only in iconic form and textural, audible or mixed mode indications can be given.

For any of the possible outcomes, the user may request the personal trust assistant to indicate what factors influenced the recommendation that it gave. The user can do this by selecting an appropriate icon on the PTA to reveal the next level of detail. This causes the display of the top level policy requirements and indicates whether they have been fulfilled. This action can be repeated for each level of the policy requirements to reveal the details of any sublevels.

Intrinsically all personal trust assistants are essentially identical and only become the electronic equivalent of the user when the two are in very close proximity. Personalisation of the device occurs once the user has identified themselves to it. The device will then either access the policies from an encrypted form within the policy memory or access the policies from an on-line repository of additional user information based and secured by the user on a remote computing system. The definition of close proximity may be a user definable feature. Thus a user may choose to require the PTA to be able to continuously acquire their biometric data. Other users may set the PTA to remain in contact with the user. Alternatively the PTA may be set to determine if it has remained within range of a beacon or transmitter that the user was wearing.

Since the personal trust assistant is only personalised when it is close to a user, it can be loaned to others and even lost without compromising the security of the original user. The new users have to insert their own biometric data memory device to enable them to authenticate to the personal trust assistant. Users may possess more than one personal trust assistant since only the one they hold or have adjacent to them will be active. This means that treating the personal trust assistant as a standard technology component that is incorporated into other appliances such as a laptop, mobile phones or personal digital assistants as standard is a very attractive option. Furthermore, the interaction between the personal trust assistant and these other appliances enhances the level of security of those appliances since they will become (or may be arranged to become) inoperative if lost or stolen.

When the personal trust assistant seeks to interface with another computing device or system, a target system, the PTA attempts to enquire the status of the target system. In order to do this it attempts to establish a secure channel to the target and then to ask specific questions about the status of the target. For example, when attempting to communicate with a trusted computing platform architecture (TCPA) enabled target system, the personal trust assistant asks the target system to disclose the revision number and status of any software items, including the operating system, as required by the policy. Whether or not the target system discloses any data may be determined by its own security policies.

The policy may also contain the user's personal preferences. Thus for certain applications, such as online banking, the user may only feel that it is safe if they are operating their device from within their own home. Therefore the personal trust assistant may seek to determine its location and factor this in to the trust computation. This geographical element to enforcement of policies becomes more relevant with employee policies where the employer may require that certain functions can be carried out on company premises only.

The personal trust assistant, when embodied within another application or device such as a mobile phone, PDA or even a personal computer can be provided as a software element.

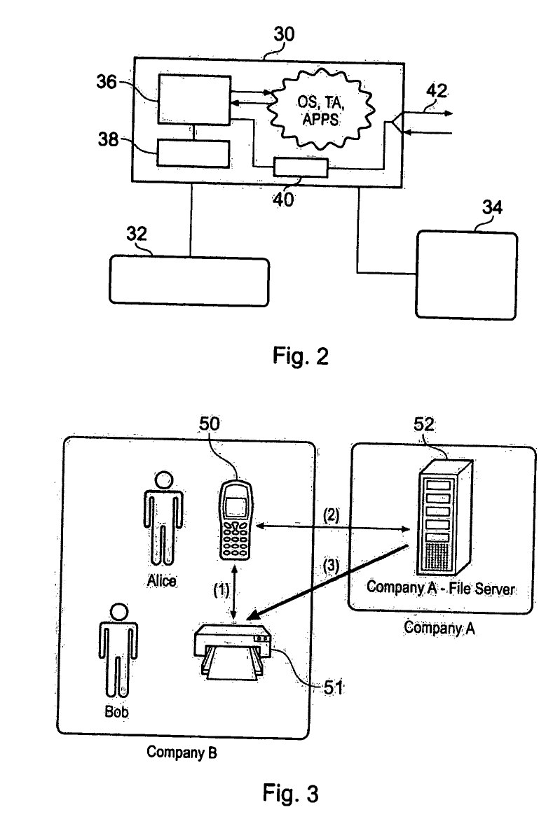

FIG. 2 schematically illustrates a personal computer 30 which has a keyboard 32, a display 34, a data processor 36 and memory 38. The computer 30 can interface with other computers via a data exchange component 40 and a local area network or the internet 42. During operation, the computer may be configured to run its operating system (OS), a trust assistant module (TA) and various applications (APPS). The trust assistant can then be invoked to investigate the computing environment attached to the computer 30 in order to assess how trustworthy that environment is.

FIG. 3 schematically illustrates a situation where a personal trust assistant facilitates the performance of the task. Suppose that Alice is a representative of a company A and she visits Bob at company B to discuss a subject of mutual interest. As the discussion proceeds, Alice realises that she has information back at her office which would strengthen her case. She desires to obtain a printed copy of this information quickly and to present it to Bob during the meeting. Ideally she would like to connect to her office computer services via Bob's corporate network and print the document locally on Bob's printer. However her company may have security policies which prevents this because:
a. Remote access to such confidential information is not permitted because it is too risky, and
b. Company B's printer is not within company A's area of trust and is deemed too high a risk.

However Alice has a personal trust assistant 50 implemented within her mobile phone and constituting an embodiment of the present invention. Alice uses her personal trust assistant to establish communication with the printer, by way of an infrared interface or a wireless local area network interface. This assumes that the printer has been configured to accept such enquiries and communications. Having established communication between the personal trust assistant 50 and the printer 51, the personal trust assistant enquires about the capabilities of the printer. For example, is its operating system such that the printer can confirm that after it has printed the document it will purge the document from its memory and will not make the document in its memory available to other devices over the corporate network. The personal trust assistant may also confirm that the printer cap under local, decryption of the document or her personal trust assistant may confirm that the corporate network will respect the integrity of the document and will purge all temporary copies of it as soon as the printing job has been completed without making such copies available to any other device on the network. If these conditions satisfy the policies laid down by Alice's employer, either globally or for the specific document, Alice can then use her personal trust assistant to establish contact with her company's file server and to select the document. She can then instruct that the document be sent for printing either directly or from the file server 52 to the printer 51 via company B's corporate network (not shown) or via a link to her mobile phone/personal trust assistant 50 and from then on to the printer 51.

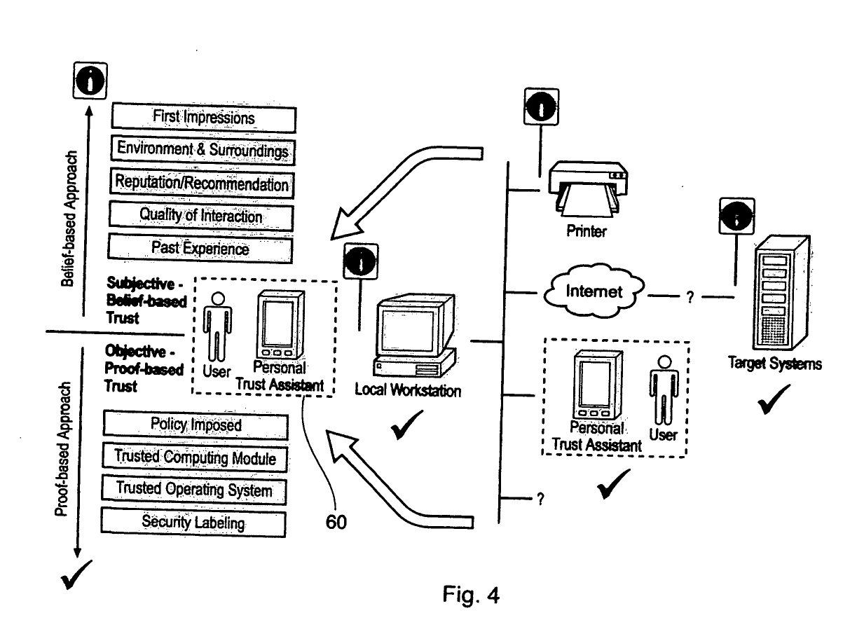

FIG. 4 schematically illustrates another situation in which the personal trust assistant may facilitate the completion of the task. In this example, the user 60 arrives for work at a hot desk centre that his employer shares with several other companies. He needs to prepare a confidential report for his company and therefore requires access to a computing facility. However because the user 60 is using an external computing facility that is also used by others and not under his company's control he has concern that the content of his report may become known to others. However using the personal trust assistant, the user 60 can connect using the wireless communications interface of his personal trust assistant to all available computing devices within the local computing domain. The personal trust assistant may make use of the IPV6 specification which gives every device, give it a display, a printer, a mouse and so on its own internet protocol address. The capabilities of each device to interact in a secure and unsubverted manner may be interrogated and a list may be produced showing all available devices and a symbol against each device indicating the level of trust that should be ascribed to that device. Thus, if a device supports the TCPA standard and has the correct software build that device can be trusted to store and process information securely. Alternatively a third party certification scheme may endorse the security of a device. Either way the user 60 is able to select those devices that support or conform to his company's security policy. He may still infact be allowed to select those devices that don't provide the right level of security if he believes that the level of risk is acceptable.

Once the devices have been selected, the personal trust assistant establishes one or more personal trust domains that encapsulate the chosen devices and enforces the company's security policy on the device. Thus, for example, the policy may state that the device must be for exclusive use by the user, that a printer can only print a document if the document owner is close by, or that all external communications must be encrypted and authenticated. The personal trust assistant can demonstrate to the user whether or not each of these requirements have been fulfilled.

A further example of use of a personal trust assistant relates to the transfer of data. Thus suppose a user wishes to send an e-mail to a third party. For simplicity we shall assume that policies associated with sending data to that specified third party have been checked and that the user has authority and permission to send the e-mail. However, the user is not using their own computer, but rather has borrowed or is using a general purpose machine.

The user is therefore anxious that no local record of the e-mail is retained on that machine. The user's personal trust assistant can check the integrity of the machine.

If the machine has a trust mechanism installed and operating, then the user can use the trust mechanism to enforce user policy on the machine and to delete all copies or traces of the e-mail on the machine. The personal trust assistant may also be instructed to check the security of the e-mail system and also, via remote interrogation, the third party PC (where it is accessible across a corporate network or is internet connected).

If the machine does not have a trusted component, but the operating system is functioning, correctly and all applications running have been identified and seem trustworthy, the user may seek to use the personal trust assistant to identify if a log of all copies within the machine of the e-mail will be kept, and if so, the user may then decide to send the e-mail and instruct the trust assistant to examine the log and cause the operating system to delete, or better still overwrite, all copies of the e-mail. Thus, to some extent the PTA can take over control of the other machine/target system so as to ensure that sensitive data is not revealed to third parties.

Even for a static computer, a trust assistant is still of use as it can probe and report on processes and devices in the computing environment.

In a further example, an individual may want to make a purchase from an online merchant. The individual may be unsure about the security that the merchant decides to offer or whether the merchant can be trusted. In particular, the user may be concerned that the data they send to the merchant may be stolen or misappropriated, and they are unsure about the ability of the merchant's computer systems to provide the protection that the user requires.

The user's expectations may be stated informally as:
1. Is the merchant taking my security seriously? In essence the site must be capable of demonstrating that it is trustworthy. This means that it must be able to report its capabilities back to the personal trust assistant in a way that can be relied upon so that the user, or more precisely the personal trust assistant, can believe the capabilities of the site. Thus the test implemented by the personal trust assistant may be to look for the presence of trusted hardware that underpins all other trust evaluation parameters, for example that the system is a TCPA.
2. Will my personal information be protected? All personal, sensitive and high risk information must be exchanged securely. This means that a secure communication channel must be established between the individual and the merchant. The personal trust assistant could check for the presence of SSL (secure socket layer) capability and a trusted computing module. This could be achieved automatically by checking the SSL certificate at each point in the process where personal information is required. A better approach would be to check for the presence of SSL at the start of the interaction and alert the user if the session becomes insecure.
3. Am I speaking to the right merchant? In essence the merchant must be able to prove that it is who it says it is. Thus the personal trust assistant may look for the presence of a certificate endorsed by a trusted third party (a trust authority). The user would need to maintain a list of acceptable trusted third parties. Even so, it would still be the responsibility of the user to check that the URL is correct for the merchant they think they are interacting with. A list of popular merchant sites could be made available by a trusted third part.
4. Is the process that the merchant operates trustworthy? Effectively the site must demonstrate that it uses proven e-commerce software. The personal trust assistant may check for the presence of a host application on the merchants site that has been validated by a trusted third party and is operating under the control of a trusted platform. Again reliance is placed on the trusted third party to provide sufficient information to carry out this test. The trusted third party could be the application writer. Alternatively a trusted platform might be able to provide assurance that the application will not leak information, but is unlikely to be able to validate its overall operation.
5. Will the merchant respect the privacy of my personal information? This requires the personal trust assistant to validate that the site complies with the user's personal privacy policy. Having specified the basic requirements for the protection of personal information, the personal trust assistant interrogates the site automatically for compliance by expressing the user's expectations to the site and measuring the response. This requires the user to be able to specify their requirements to the trusted third party, or alternatively to be able to accept the specification defined for them by the trusted third party.
6. Do I feel good about this merchant? This question represents one of the subjective parameters that can be evaluated by the personal trust assistant. Essentially the user is looking for good reports from others or from a trusted or well respected assessor. Essentially the personal trust assistant is relying on advice from a trusted third party or from the user's past experience.

An exemplary trust policy is defined below.

It is thus possible to provide users with a device and process for determining how trustworthy their environment is:

[Thresholds]
Threshold=1-25; 26-50; 51-75; 76-100

[Target System Parameters]
TCPA=True
TCPA Revision=1.0, 1.1
TCPA Root Authority=HP
Operating System=Trusted Linux, Trusted Windows
Application=e-Commerce Plus
Link Security=SSL

“Threshold” defines four sub-ranges (in the overall range of 1-100) that map onto the four levels of advice offered to the user as follows:

| | | |
|---|---|---|
| 76-100 | = | Policy fulfilled-safe to proceed |
| 51-75 | = | Policy partially fulfilled-proceed with caution |
| 26-50 | = | Policy partially fulfilled-procedure not recommended |
| 1-25 | = | Policy not fulfilled-not safe to proceed |

One approach is to assume that each parameter contributes an equal trust value to the overall computation. So, in the above example, each target system parameter contributes 20, and if all five parameters are fulfilled then the trust score is 100.

A more sophisticated approach is to assign individual trust values to each parameter, as in the following example policy (trust values shown bracketed):

[Thresholds]
Threshold=1-25; 26-50; 51-75; 76-100

[Target System Parameters]
TCPA Revision=1.0 (15), 1.1 (20)
TCPA Root Authority=HP (50)
Operating System=Trusted Linux (30), Trusted Windows (25)
Application=e-Commerce Plus (40)
Link Security=SSL (90)
   Here, each parameter contributes a variable proportion depending on how significant it is to the desired level of security. (The values will be normalised to the 1-100 scale in the final computation.) The values assigned to each parameter need to be determined beforehand by someone expert in risk assessment. In determining the value to assign to each parameter, thought must be given to the effect of (say) two lesser parameters being fulfilled. For example, in this example SSL contributes 90/270 points, and is therefore sufficient alone to give a “proceed with caution” indication. However, TCPA and ‘Root Authority=HP’ together produce a similar outcome. So numerical value alone will not always be sufficient.

This approach can be extended to incorporate a formal risk assessment methodology, whereby each parameter is assigned a risk rating. The risk rating states the likelihood of a parameter failing to fulfil its objective. For example, the target system may be required to provide TCPA, a trusted OS and SSL. These three parameters combine to provide a secure target system (TCPA and trusted OS) and a secure communications channel (SSL).

Together they define the level of security required, but each grouping satisfies a slightly different need. The overall assessment is based on both groups being present (ie SSL) AND (TCPA AND T.OS). The effectiveness of each component is determined from the likelihood and skill necessary to perform a successful attack.

Where a policy allows more than one approach (e.g. SSL or ‘HP encryption’), the OR operator can be used in the computation giving (SSL OR HP Encryption) AND (TCPA AND T.OS).

This is a difficult determination. It may be that for a given situation SSL is the most important factor, followed by TCPA and then T.OS. Consequently, each parameter is given a “likelihood of failure” value. This could be expressed as time between failures or as a probability. Having assigned values to each parameter, a simple probability tree-type calculation can reveal the overall value for the target system. The computation process highlights when a key parameter is missing.

Further information on this approach can be found in the book “Probabilistic Risk Assessment and Management for Engineers and Scientists”, 2nd Ed, Hiromitsu Kumamoto, Ernest J Henley, IEEE Press 1996, ISBN:0-7803-6017-6.

A third approach, is to define different policies (four in this case) for each level of trust indication. The threshold is no longer required and the assessment is made simply by matching policy to measurement. For example:

Policy Fulfilled

[Target System Parameters]
TCPA Revision=1.0, 1.1
TCPA Root Authority=HP
Operating System=Trusted Linux
Application=e-Commerce Plus
Link Security=SSL

Policy Partially Fulfilled—Proceed With Caution

[Target System Parameters]
TCPA Revision=1.0, 1.1
TCPA Root Authority=HP
Operating System=Trusted Windows
Link Security=SSL

Policy Partially Fulfilled—Procedure Not Recommended

[Target System Parameters]
TCPA Revision=1.0, 1.1
Link Security=SSL

Policy Not Fulfilled—Not Safe to Proceed

[Target System Parameters]
Link Security=SSL

An evaluation that doesn't exactly match any policy would be raised as an exception or processed according to other rules, e.g. best fit. As before, expert knowledge of risk assessment is required to be able to define these policies.

The next three lines of the policy (starting at link security=SSL) define the expectations of the web server, and in particular that SSL is enabled and 40 bit encryption or better is used.
[symbol] SSL Encryption=40 bit
[symbol] SSL Client Certificate=True
[symbol] User Authentication Policy=Policy A

[Personal Policy Parameters]
Recommendation Rating=3* or better
Data Tag=Open=>Can send in clear
Data Tag=Personal, Private =>Encrypt 128 bit SSL

The personal policy parameters indicate that recommendations of the site from a trusted third party where the site is rated 3 or better in accordance with the measurement scheme implemented by that third party causes the site to be deemed trustworthy.

Open information can be sent in clear (unencrypted format) whereas information which in accordance with the policy is defined as personal or private is sent using 128 bit encryption.

[PTA Environmental Parameters]
Safe Location=Home, work

[Target System Environmental Parameters]
Safe Location=Government building (including Ordinance Survey grid co-ordinates).

The final few lines of the policy define environmental parameters, such that safe locations are defined as being at home and work and safe target systems can also be defined by their geographical position.

It is thus possible to provide a trust assistant for evaluating security of a computing system.

1. An apparatus for evaluating security or trust within a data processing or transactional environment, comprising:
a data processor arranged to interrogate the data processing or transactional environment to determine what devices or applications exist with the environment and their operating state, to evaluate this data and to provide an indication of the security of the environment or trust that can be placed in the environment.

2. An apparatus as claimed in claim 1, wherein the apparatus further includes a policy memory for the storing at least one policy defining what conditions are to be met for a data processing or transactional environment to be considered as meeting an acceptable level of security or trust.

3. An apparatus as claimed in claim 2, wherein a plurality of policies are provided in the policy memory and a user can select which policy is appropriate.

4. An apparatus as claimed in claim 3, wherein one policy is an employers/work policy and another policy is an individual's private use policy.

5. An apparatus as claimed in claim 1, in which the data processing environment is a first data processing environment and the apparatus can selectively make contact with other data processing environments and can act on behalf of those other data processing environments to provide an indication of trust of the first data processing environment.

6. An apparatus as claimed in claim 1 in which the apparatus requires a user to authenticate themselves or identify themselves to it before it will enforce a user's policies.

7. An apparatus as claimed in claim 6, in which authentication or identification is performed by one item selected from a list comprising entering a personal code, biometric identification and use of a physical device or key to identify the user.

8. An apparatus as claimed in claim 7, in which the biometric identification includes at least one item selected from voice analysis, finger print analysis hand pattern analysis, retinal scanning and iris scanning.

9. An apparatus as claimed in claim 6, in which the apparatus requires proximity to or contact with the user to be maintained in order for user's to be maintained.

10. An apparatus as claimed in claim 6, in which the apparatus retrieves the user's policy from a secure store after user authentication.

11. An apparatus as claimed in claim 10, in which the store is held on a remote computer, and the policy is down loaded to the apparatus.

12. An apparatus as claimed in claim 11, in which the policy is downloaded in encrypted form.

13. An apparatus as claimed in claim 1, in which the apparatus further evaluates environmental information.

14. An apparatus as claimed in claim 13, in which proximity sensors are provided to determine the proximity of other people to the user.

15. An apparatus as claimed in claim 13 where position determining means are provided for determining the position of the device.

16. An apparatus as claimed in claim 15, wherein the apparatus determines its position by virtue of triangulating its position with respect to radio or telephone transmitters whose positions are known.

17. An apparatus as claimed in claim 15, whereby a radio telecommunications network monitors a transmission from the device, calculates its position and transmits it to the device.

18. An apparatus as claimed in claim 15, wherein the apparatus includes a GPS receiver for determining the position of the device.

19. An apparatus as claimed in claim 13 further including a clock for determining the time.

20. An apparatus as claimed in claim 13, wherein the apparatus is responsive to at least one of proximity of other persons, time and position and it uses this data, in association with a set of environmental rules to give an indication of security or trust.

21. An apparatus whereby an iconic, textural or graphical indication of trust is given to the user by the apparatus.

22. A method of evaluating security or trust within a data processing or transactional environment, comprising the steps of:
selecting a policy defining what conditions are to be met for a data processing or transactional environment to be considered as corresponding to an acceptable level of trust;
investigating devices or applications within the environment to determine their operating state; and
providing an indication of the trust that can be placed in the environment.

23. A method as claimed in claim 22, in which different policies are available for different data processing or transactional activities.

24. A method as claimed in claim 22 in which a user must authenticate their identity before the investigation means or agent is enabled.

25. A method as claimed in claim 24, in which the authentication is provided by password identification, key identification or biometric identification.

26. A method as claimed in claim 22 in which a user's position, time of day and proximity to others is taken into account when evaluating a level of trust or security.

27. A computer program product for causing a data processor to operate in accordance with the method as claimed in claim 22.

28. A personal trust assistant comprising a portable data processing device having a policy memory for holding at least one trust policy giving indications of at least one item selected from a list comprising conditions to be satisfied for an environment to be considered safe, conditions to be satisfied for an environment to be considered trusted, and conditions which cause an environment to be considered unsafe or untrusted, and environment sensors for collecting environmental information, and wherein the data processor compares the environmental information with the policies and on the basis of the comparison gives an indication to the user of the safety or trust of the environment.

29. A personal trust assistant as claimed in claim 28, in which the personal trust assistant can assume at least limited control of a target system.

30. A personal trust assistant as claimed in claim 29 in which the personal trust assistant acts as an agent for the user.

31. A personal trust assistant as claimed in claim 29 in which the personal trust assistant acts as an identity manager for the user.

32. A policy server arranged to, upon establishment of communication with a personal trust assistant, seek confirmation of a user identity, to locate a user's at least one policy, and to download at least a selected one of the user's policies to the personal trust assistant for use by the personal trust assistant.
